(19) United States
(12) Patent Application Publication
(10) Pub. No.: US 2026/0267268 A1
(43) Pub. Date: Sep. 10, 2026

(54) IMAGE FORMING APPARATUS

(71) Applicant: Konica Minolta, Inc., Tokyo (JP)

(72) Inventor: Yuusuke MANDAI, Kyoto (JP)

(21) Appl. No.: 19/550,494

(22) Filed: Feb. 26, 2026

(30) Foreign Application Priority Data
Mar. 6, 2025 (JP) 2025-035356

(51) Int. Cl. G03G 15/00; G03G 15/095; G03G 21/00; G06K 15/00

(52) U.S. Cl. CPC G03G 15/55; G03G 15/095; G03G 21/0005; G06K 15/407; G06K 15/408

(57) ABSTRACT

Provided is an image forming apparatus including: a photoreceptor drum; a developer carrier; a cleaning member that removes transfer residual toner remaining on the photoreceptor drum after transfer to a transfer body; an optical sensor that detects a toner amount of fog toner; and a hardware processor that sets a fog margin. The hardware processor predicts a charge distribution of toner in a developing apparatus based on a fog transfer characteristic, calculates a transfer residual fog toner amount by using the sensor output corresponding to the set fog margin and transfer efficiency set in association with the charge distribution, and sets the fog margin such that the transfer residual fog toner amount is equal to or greater than a first target value set in advance.

### CROSS REFERENCE TO RELATED APPLICATIONS

The entire disclosure of Japanese Patent Application No. 2025-035356, filed on Mar. 6, 2025, is incorporated herein by reference in its entirety.

### BACKGROUND

### Technological Field

The present disclosure relates to an image forming apparatus.

### Description of Related Art

In an image forming apparatus (a printer, a copying machine, a facsimile, or the like) using an electrophotographic process technology, laser light based on image data is emitted (exposed) to a uniformly charged photoreceptor drum so that an electrostatic latent image is formed on a surface of the photoreceptor drum. Then, toner is supplied to the photoreceptor drum, whereby the electrostatic latent image is visualized as a toner image. The toner image is transferred onto a recording material, and is then heated and pressurized at a fixing section. Through the above process, an image is formed on the recording material.

In the developing process, toner may adhere to a non-image portion on the photoreceptor drum. The “non-image portion” is a portion (unexposed portion) to which toner should not adhere in the first place, and corresponds to a white background portion when an image is formed on a recording material. The image defect caused by the transfer of toner onto a recording material is called “toner fog”. Toner that adheres to a non-image portion on a photoreceptor drum and may cause toner fog will be referred to as “developing fog toner”.

Part of the developing fog toner is transferred onto a transfer body such as an intermediate transfer belt or a recording material. The remainder of the developing fogging toner remains on the photoreceptor drum and is removed by a cleaning member such as a cleaning blade. Fog toner transferred onto a transfer body will be referred to as “transfer fog toner”, and fog toner remaining on a photoreceptor drum will be referred to as “transfer residual fog toner”. Transfer residual fog toner and an external additive act as a lubricant, thereby reducing a friction force between a photoreceptor drum and a cleaning member and suppressing the wear of the photoreceptor drum and the cleaning member.

Toner fog can be suppressed by setting an appropriate fog margin (see, for example, Patent Literatures (hereinafter, “Patent Literature” will be referred to as “PTL”) 1 (Japanese Patent Publication Laid-Open No. 2022-18663) and 2 (Japanese Patent Publication Laid-Open No. 2023-58347)). The fog margin is, for example, the potential difference between the surface potential of a photoreceptor drum and the surface potential of a developer carrier (for example, a developing roller), and is indicated by a difference between a charging bias and a developing bias. When the fog margin is set to be large, the toner is strongly attracted to the developer carrier and hardly flies to the side of the photoreceptor drum. As a result, the developing fog toner is reduced, and toner fog can be suppressed. However, when the fog margin is set to be excessively large, the developing fog toner is further reduced, and the effect of suppressing the wear of the photoreceptor drum and the cleaning member due to the transfer residual fog toner decreases. For this reason, it is important to set a fog margin appropriately so as to ensure a required minimum amount of transfer residual fog toner.

For example, PTL 1 discloses that an appropriate amount of transfer residual fog toner is supplied to a cleaning member by changing a fog margin according to an evaluation amount (for example, the number of printed sheets per day) related to the operation frequency of a developing apparatus. In addition, for example, PTL 2 discloses that transfer fog toner on an intermediate transfer belt or developing fog toner on a photoreceptor drum is detected by an optical sensor, and a fog margin is set based on the detection result.

Incidentally, it is known that the east of occurrence of developing fog toner is affected by the charged state (for example, average charge amount and distribution shape) of toner in a developing apparatus. It can be said that PTL 1 utilizes the evaluation amount related to the operation frequency of the developing apparatus as an index indicating the charged state of the toner in the developing apparatus. However, it is difficult to accurately grasp the charged state of toner based on the evaluation amount related to the operation frequency of the developing apparatus, and an appropriate amount of transfer residual fog toner may not be supplied to the cleaning member.

### SUMMARY

An object of the present disclosure is to provide an image forming apparatus capable of suppressing toner fog and suppressing deterioration of a photoreceptor drum and a cleaning member by supplying an appropriate amount of transfer residual fog toner.

### Solution to Problem

In order to achieve at least one of the above objects, an image forming apparatus reflecting one aspect of the present disclosure includes:
a photoreceptor drum;
a developer carrier that supplies toner to the photoreceptor drum; and
a cleaning member that removes transfer residual toner remaining on the photoreceptor drum after transfer to a transfer body;
an optical sensor that detects a toner amount of fog toner; and
a hardware processor that sets a fog margin.
The hardware processor
   predicts a charge distribution of toner in a developing apparatus based on a fog transfer characteristic indicating a sensor output of the optical sensor when the fog margin is changed in a stepwise manner,
   calculates a transfer residual fog toner amount by using the sensor output corresponding to the set fog margin and transfer efficiency set in association with the charge distribution, and
   sets the fog margin such that the transfer residual fog toner amount is equal to or greater than a first target value set in advance.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram schematically illustrating an overall configuration of an image forming apparatus;

FIG. 2 is a diagram illustrating a main part of a control system of the image forming apparatus;

FIG. 3 is a diagram illustrating a specific configuration around a photoreceptor drum;

FIG. 4 is a diagram illustrating an example of a fog transfer characteristic;

FIG. 5 is a diagram illustrating experimentally obtained primary transfer efficiency of developing fog toner;

FIGS. 6A to 6C are model diagrams illustrating examples of a charge distribution of toner in a developing apparatus;

FIGS. 7A and 7B are model diagrams illustrating other examples of charge distributions of the toner in the developing apparatus;

FIGS. 8A and 8B are diagrams illustrating relationships between the fog margin set according to the charge distribution and the primary transfer efficiency; and

FIG. 9 is a flowchart illustrating an example of fog margin setting processing.

### DETAILED DESCRIPTION OF EMBODIMENTS

Hereinafter, one or more embodiments of the present invention will be described with reference to the drawings. However, the scope of the invention is not limited to the disclosed embodiments.

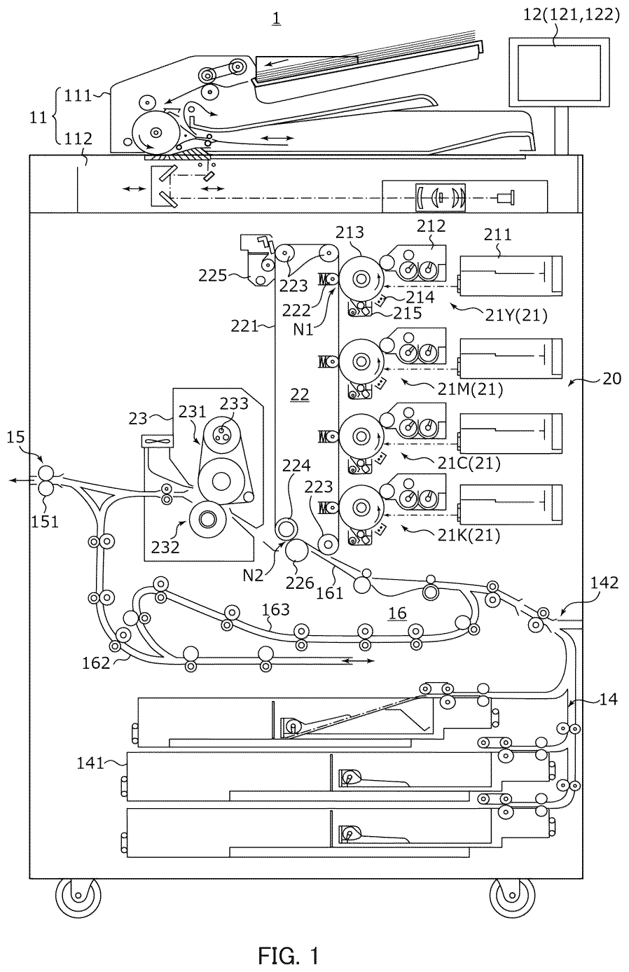

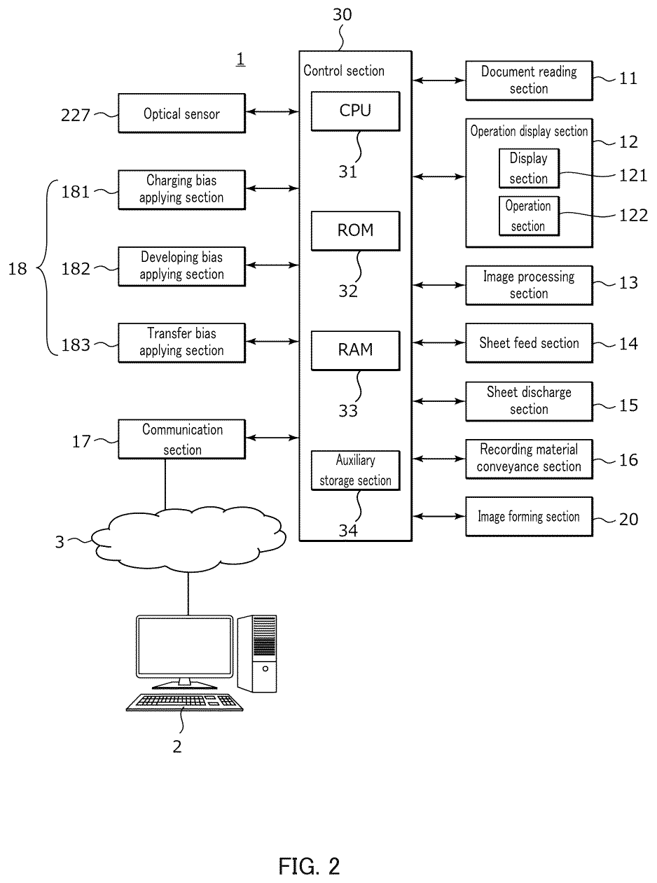

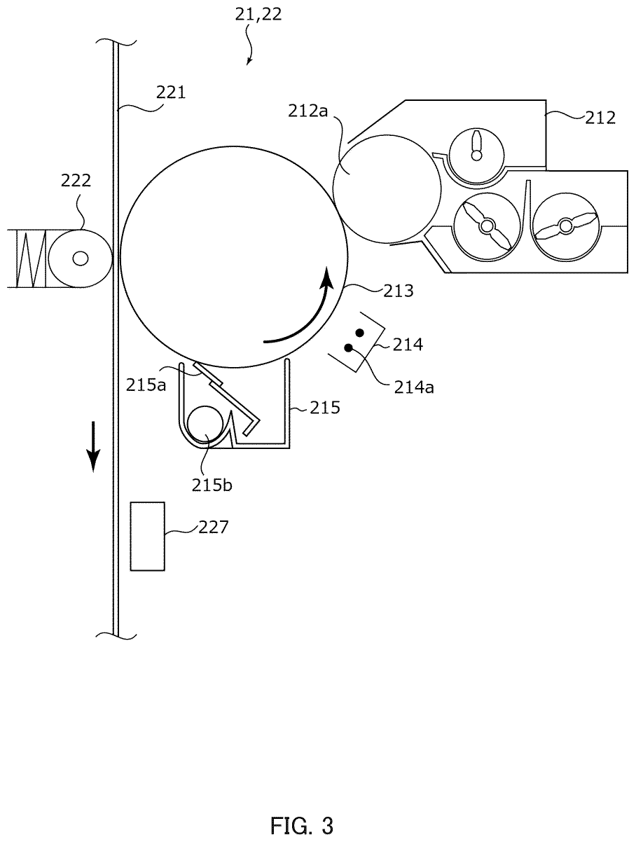

FIG. 1 is a diagram schematically illustrating an overall configuration of an image forming apparatus 1 according to an embodiment. FIG. 2 is a diagram illustrating a main part of a control system of the image forming apparatus 1. FIG. 3 is a diagram illustrating a specific configuration around a photoreceptor drum 213.

The image forming apparatus 1 is a color image forming apparatus of an intermediate transfer method utilizing an electrophotographic process technology. The image forming apparatus 1 primary-transfers toner images of respective colors of yellow (Y), magenta (M), cyan (C), and black (K) formed on the photoreceptor drums 213 onto an intermediate transfer belt 221. In addition, the image forming apparatus 1 superimposes the toner images of the four colors on the intermediate transfer belt 221, and then secondary-transfers the toner images onto a recording material, thereby forming an image.

In the present embodiment, the image forming apparatus 1 adopts a vertical tandem system. In the vertical tandem system, the photoreceptor drums 213 corresponding to the four colors of CMYK are arranged in series along the traveling direction (vertical direction) of the intermediate transfer belt 221, and toner images of the respective colors are sequentially transferred onto the intermediate transfer belt 221 by a single procedure.

As illustrated in FIGS. 1 and 2, the image forming apparatus 1 includes a document reading section 11, an operation display section 12, an image processing section 13, a sheet feed section 14, a sheet discharge section 15, a recording material conveyance section 16, a communication section 17, a power supply section 18, an image forming section 20, a control section 30, and the like. The image forming section 20 includes an imaging section 21, an intermediate transfer section 22, and a fixing section 23. The power supply section 18 includes a charging bias applying section 181, a developing bias applying section 182, and a transfer bias applying section 183.

The control section 30 performs overall control of the image forming apparatus 1 by controlling the document reading section 11, the operation display section 12, the image processing section 13, the sheet feed section 14, the sheet discharge section 15, the recording material conveyance section 16, the communication section 17, the power supply section 18, and the image forming section 20 according to the respective functions thereof.

The control section 30 is a hardware processor including a central processing unit (CPU) 31 serving as an arithmetic/control apparatus, a read only memory (ROM) 32 and a random access memory (RAM) 33 serving as main storage apparatuses, and the like. The control section 30 may include an auxiliary storage section 34 formed by a non-volatile semiconductor memory (so-called flash memory) such as a hard disk drive (HDD), a solid state drive (SSD), or a secure digital (SD) card.

The ROM 32 stores a basic program and basic setting data. In addition, the ROM 32 accommodates a program, a look-up table, and the like, which are read when the operation of each block is controlled. The CPU 31 reads a program corresponding to the processing content from the ROM 32, develops the program in the RAM 33, and executes the developed program, thereby controlling the operation of each function block of the image forming apparatus 1.

In the present embodiment, each hardware constituting the function blocks and the control section 30 operate in cooperation with each other, thereby implementing the functions of the function blocks. Note that, the functions of some or all of the functional blocks may be implemented by the control section 30 executing a program. In addition, some or all of pieces of processing to be executed by the control section 30 may be executed by an electronic circuit provided according to the processing. Examples of the electronic circuit include a digital signal processor (DSP), an application specific integrated circuit (ASIC), and a programmable logic device (PLD).

In addition, the control section 30 transmits and receives various data to and from an external apparatus 2 (for example, a personal computer) connected to a network 3 such as a local area network (LAN) or a wide area network (WAN) via the communication section 17. The communication section 17 is, for example, a communication interface such as a network interface card (NIC), a MOdulator-DEModulator (MODEM), or a universal serial bus (USB). The communication section 17 may include a communication interface for short-range wireless communication such as Near Field Communication (NFC) or Bluetooth (registered trademark).

The control section 30 receives, for example, print job data transmitted from the external apparatus 2, and generates input image data based on the received print job data. The print job data is described in a predetermined page description language (PDL). The print job data includes, for example, data of image objects such as graphics and photographs, and data of text objects such as characters and symbols. The generated input image data is temporarily stored in an image memory (illustration is omitted).

The document reading section 11 includes an automatic document feed apparatus 111 referred to as an auto document feeder (ADF), a document image scanning apparatus 112, and the like.

The automatic document feed apparatus 111 conveys a document placed on a tray by a conveyance mechanism and sends the document to the document image scanning apparatus 112. The automatic document feed apparatus 111 makes it possible to continuously read images (including both surfaces) of a large number of documents placed on the document tray.

The document image scanning apparatus 112 reads a document conveyed from the automatic document feed apparatus 111 onto a contact glass or a document placed on the contact glass. Specifically, the document image scanning apparatus 112 optically scans a document, and reads a document image by forming, on a light receiving surface of an imaging element (for example, a charge coupled device (CCD)), an image of reflected light from the document. The document reading section 11 generates input image data based on a reading result by the document image scanning apparatus 112. The generated input image data is temporarily stored in the image memory (illustration is omitted).

The operation display section 12 is configured by, for example, a flat panel display with a touch screen. As the flat panel display, a liquid crystal display, an organic EL display, or the like can be used. The operation display section 12 includes a display section 121 and an operation section 122.

The display section 121 displays various operation screens, an image state, an operation status of each function, and the like according to a display control signal inputted from the control section 30.

The operation section 122 includes various operation keys such as a numeric keypad and a start key. The operation section 122 receives various input operations by a user, and outputs an operation signal to the control section 30. A user can operate the operation display section 12 to perform settings related to image formation, such as document setting, image quality setting, magnification setting, application setting, output setting, and recording material setting.

The image processing section 13 includes a circuit and the like that applies digital image processing to input image data according to initial settings or user settings. The image processing section 13 performs, for example, information extraction processing, image conversion processing, image conversion processing, image filtering processing, and correction processing. The image forming section 20 is controlled based on the image data on which the pieces of processing described above have been performed.

Based on the input image data, the imaging section 21 forms toner images with color toners of a Y component, an M component, a C component, and a K component. The intermediate transfer section 22 transfers the toner images formed by the imaging section 21 onto a recording material. The fixing section 23 fixes the transferred toner images to the recording material.

Specifically, the image forming sections 21 is constituted by four imaging sections 21Y, 21M, 21C, and 21K for Y, M, C, and K components. Since the imaging sections 21Y, 21M, 21C, and 21K have the same configuration, it is configured such that common constituent elements are denoted by the same reference signs for convenience of illustration and description, and that in a case where common constituent elements are distinguished from each other, the common constituent elements are denoted by adding Y, M, C, and K to the reference signs thereof. Note that, in FIG. 1, reference signs are provided to the constituent elements of the imaging section 21Y for the Y component and the reference signs of the constituent elements of the other imaging sections 21M, 21C, and 21K are omitted.

The imaging section 21 includes an exposure apparatus 211, a developing apparatus 212, a photoreceptor drum 213, a charging apparatus 214, a drum cleaning apparatus 215, and the like. Although illustration is omitted, the imaging section 21 may include a discharging apparatus for removing residual charge remaining on the surface of the photoreceptor drum 213 after the primary transfer.

The photoreceptor drum 213 is, for example, a negatively chargeable organic photoreceptor drum (OPC: Organic Photo-conductor). The photoreceptor drum 213 has, for example, a configuration in which an undercoat layer, a charge generation layer, and a charge transport layer are sequentially stacked on the peripheral surface of a conductive cylindrical body (aluminum tube) made of aluminum.

The charge generation layer is composed of an organic semiconductor in which a charge generating material (for example, phthalocyanine pigment) is dispersed in a resin binder (for example, polycarbonate). The charge generation layer generates a pair of positive charge and negative charge upon exposure by the exposure apparatus 211. The charge transport layer has a configuration in which a hole transport material (electron-donating nitrogen-containing compound) is dispersed in a resin binder (for example, polycarbonate resin). The charge transport layer transports the positive charges generated in the charge generation layer to the surface of the charge transport layer.

The charging apparatus 214 is constituted by, for example, a corona discharge generator such as a scorotron charging apparatus or a corotron charging apparatus. The control section 30 controls the charging bias applying section 181 such that a charging bias is applied to the charging apparatus 214. The charging bias applying section 181 is, for example, a direct-current power supply circuit. The charging apparatus 214 generates corona discharge by the application of the charging bias and uniformly charges the surface of the photoreceptor drum 213 to a negative polarity. The surface potential of the photoreceptor drum 213 depends on the charging bias.

The exposure apparatus 211 is constituted by, for example, an LED print head (LPH). The LPH includes an LED array, an LPH drive section (driver IC), a lens array, and the like. In the LED array, a plurality of light emitting diodes (LEDs) is linearly arranged. The LPH drive section drives the individual LEDs. The lens array forms an image of the light emitted from the LED array on the photoreceptor drum 213. One LED of the LED array corresponds to one dot of an image.

The exposure apparatus 211 emits light corresponding to an image of each color component to the photoreceptor drum 213. The positive charges generated in the charge generation layer of the photoreceptor drum 213 by light emission are transported to the surface of the charge transport layer, and thus, the surface charges (negative charges) on the photoreceptor drum 213 are neutralized. Thus, an electrostatic latent image of each color component is formed on the surface of the photoreceptor drum 213 due to a potential difference from the surroundings thereof.

The developing apparatus 212 accommodates a developer (for example, a two-component developer including toner and a carrier) of each color component and causes the toner of each color component to adhere to the surface of the photoreceptor drum 213 to visualize the electrostatic latent image and form a toner image. The control section 30 controls the developing bias applying section 182 such that a developing bias is applied to a developer carrier 212a. The developing bias applying section 182 is, for example, a direct-current power supply circuit. The developing bias applying section 182 may include an alternating-current power supply circuit in addition to the direct-current power supply circuit. The developer carrier 212a is, for example, a developing roller.

A developing bias is applied to the developer carrier 212a, and an electric field is formed between the photoreceptor drum 213 and the developer carrier 212a. Due to the potential difference between the photoreceptor drum 213 and the developer carrier 212a, the charged toner on the developer carrier 212a flies to an image portion (exposed portion) of the surface of the photoreceptor drum 213 and adheres as normal toner. Thus, the electrostatic latent image on the photoreceptor drum 213 is visualized. In addition, the charged toner on the developer carrier 212a also flies to a non-image portion of the surface of the photoreceptor drum 213 and adheres as developing fog toner.

The drum cleaning apparatus 215 removes transfer residual toner remaining on the surface of the photoreceptor drum 213 after the primary transfer. The transfer residual toner includes transfer residual toner of normal toner and transfer residual fog toner. The drum cleaning apparatus 215 is, for example, together with the photoreceptor drum 213, integrally attached as a photoreceptor drum unit to the image forming apparatus 1.

The drum cleaning apparatus 215 includes a drum cleaning blade 215a that abuts on the surface of the photoreceptor drum 213. The drum cleaning blade 215a is an elastic member obtained by molding urethane rubber or the like into a flat plate shape. The drum cleaning blade 215a has a width substantially equal to the width of the photoreceptor drum 213 in the longitudinal direction (the main scanning direction). The drum cleaning blade 215a is disposed, for example, so as to come into sliding contact with the photoreceptor drum 213 at a predetermined contact angle (for example, 15°) from a counter direction (the direction in which an edge portion thereof extends when the photoreceptor drum 213 rotates).

The drum cleaning blade 215a scrapes off transfer residual toner remaining on the surface of the photoreceptor drum 213 as the photoreceptor drum 213 rotates. The scraped transfer residual toner is fed out to a waste toner collecting container (illustration is omitted) by a toner collecting screw 215b. The transfer residual toner supplied to the drum cleaning apparatus 215 acts as a lubricant, and thus, the friction force between the photoreceptor drum 213 and the drum cleaning blade 215a is reduced, and the wear of the photoreceptor drum 213 and the drum cleaning blade 215a is suppressed.

The intermediate transfer section 22 includes the intermediate transfer belt 221, a primary transfer roller 222, a plurality of support rollers 223 and 224, a belt cleaning apparatus 225, a secondary transfer roller 226, an optical sensor 227, and the like.

The intermediate transfer belt 221 is an image carrier that carries a toner image, and is a transfer target onto which the toner image on the photoreceptor drum 213 is transferred. The intermediate transfer belt 221 is constituted by a belt having an endless shape and is stretched in a loop shape over the plurality of support rollers 223. At least one of the plurality of support rollers 223 is constituted by a drive roller, and the others are constituted by driven rollers. The rotation of the drive roller causes the intermediate transfer belt 221 to travel at a constant speed.

The primary transfer roller 222 is disposed on the inner peripheral surface side of the intermediate transfer belt 221 to face the photoreceptor drum 213 of each color component. The primary transfer roller 222 is brought into pressure contact with the photoreceptor drum 213 with the intermediate transfer belt 221 interposed therebetween, thereby forming a primary transfer nip for transferring a toner image from the photoreceptor drum 213 onto the intermediate transfer belt 221. The control section 30 controls the transfer bias applying section 183 such that a primary transfer bias is applied to the primary transfer roller 222.

The support roller 223 includes an opposing roller 224 disposed to face the secondary transfer roller 226. The secondary transfer roller 226 is disposed on the outer peripheral surface side of the intermediate transfer belt 221, and is brought into contact with the opposing roller 224 with the intermediate transfer belt 221 interposed therebetween. Thus, a secondary transfer nip for transferring a toner image from the intermediate transfer belt 221 onto a recording material is formed. The control section 30 controls the transfer bias applying section 183 such that a secondary transfer bias is applied to the secondary transfer roller 226.

At the primary transfer nip, toner images on the photoreceptor drum 213 are sequentially superposed and primary-transferred onto the intermediate transfer belt 221. Specifically, when a primary transfer bias is applied to the primary transfer roller 222, a charge having a polarity opposite to that of the toner is imparted to the inner peripheral surface side of the intermediate transfer belt 221 (the side on which the primary transfer roller 222 abuts). The toner image is electrostatically transferred from the photoreceptor drum 213 onto the intermediate transfer belt 221.

Thereafter, when the recording material passes through the secondary transfer nip, the toner image on the intermediate transfer belt 221 is secondary-transferred onto the recording material. Specifically, when a secondary transfer bias is applied to the secondary transfer roller 226, a charge having a polarity opposite to that of the toner is imparted to the back surface side of the recording material (the side on which the secondary transfer roller 226 abuts). The toner image is electrostatically transferred from the intermediate transfer belt 221 onto the recording material. The recording material onto which the toner image has been transferred is conveyed toward the fixing section 23.

The belt cleaning apparatus 225 includes a belt cleaning blade (reference sign is omitted) that comes into sliding contact with the surface of the intermediate transfer belt 221. The belt cleaning apparatus 225 removes transfer residual toner remaining on the surface of the intermediate transfer belt 221 after the secondary transfer.

The optical sensor 227 is disposed on the downstream side of the intermediate transfer belt 221 in the traveling direction thereof with respect to the primary transfer nip of each of the imaging sections 21Y, 21M, 21C, and 21K. The optical sensor 227 detects the toner concentration (the toner adhesion amount) of the toner image transferred onto the intermediate transfer belt 221 in a non-contact manner. For example, a reflection-type optical sensor including a light emitting element, such as a light emitting diode (LED), and a light receiving element, such as a photodiode (PD), is applicable to the optical sensor 227.

Specifically, the optical sensor 227 is capable of detecting the toner concentration of normal toner that has adhered to an image portion of the photoreceptor drum 213 and has been transferred onto the intermediate transfer belt 221. In addition, the optical sensor 227 is capable of detecting the toner concentration of transfer fog toner that has adhered to a non-image portion of the photoreceptor drum 213 and has been transferred onto the intermediate transfer belt 221.

The fixing section 23 includes an upper fixing section 231, a lower fixing section 232, a heating source 233, a pressure contact/separation section (illustration is omitted), and the like. The upper fixing section 231 includes a fixing surface-side member disposed on the side of the fixing surface (the surface on which a toner image has been formed) of the recording material. The lower fixing section 232 includes a back surface-side support member disposed on the side of the back surface (the surface opposite to the fixing surface) of the recording material. The heating source 233 heats the fixing surface-side member. The pressure contact separation part brings the back surface-side support member into pressure contact with the fixing surface-side member.

The recording material onto which a toner image has been secondary-transferred and which has been conveyed along a sheet passing path is heated and pressurized when passing through the fixing section 23. Thus, the toner image is fixed on the recording material.

The sheet feed section 14 includes a sheet feed tray 141 and a manual sheet feed section 142. In the sheet feed tray 141, flat cut sheets (standard sheets and special sheets) identified based on the basis weight, the size, and the like are accommodated for each sheet type set in advance. A plurality of sheet feed roller sections (reference signs are omitted) are disposed in the sheet feed tray 141 and the manual sheet feed section 142. An external sheet feed apparatus (illustration is omitted) having a large capacity can be connected to the manual sheet feed section 142. The external sheet feed apparatus may be capable of feeding continuous sheet such as a roll sheet, for example. The sheet feed section 14 feeds out a recording material, which has been fed from the sheet feed tray 141 or the manual sheet feed section 142, to the recording material conveyance section 16.

The sheet discharge section 15 includes a sheet discharge conveyance roller section 151. The sheet discharge section 15 discharges a recording material, which has been fed out from the recording material conveyance section 16, to the outside of the apparatus.

The recording material conveyance section 16 includes a main conveyance section 161, a switchback conveyance section 162, a back surface printing conveyance section 163, a sheet passing path switching section (illustration is omitted), and the like. Part of the recording material conveyance section 16 may be, for example, incorporated into one unit together with the fixing section 23, and may be detachably attached to the image forming apparatus 1.

The main conveyance section 161 includes a recording material conveyance element that nips and conveys a recording material. The recording material conveyance element includes, for example, a plurality of conveyance roller sections (reference sign is omitted) including a loop roller section and a registration roller section. The main conveyance section 161 conveys a recording material, which has been fed from the sheet feed section 14, and passes the recording material through the image forming section 20 (the intermediate transfer section 22 and the fixing section 23). In addition, the main conveyance section 161 conveys a recording material, which has been fed out from the image forming section 20 (fixing section 23), toward the sheet discharge section 15 or the switchback conveyance section 162.

The switchback conveyance section 162 temporarily stops a recording material, which has been fed out from the fixing section 23, reverses the conveyance direction, and conveys the recording material to the sheet discharge section 15 or the back surface printing conveyance section 163.

The back surface printing conveyance section 163 circulates and conveys a recording material, which has been switched back by the switchback conveyance section 162, to the main conveyance section 161. The recording material is passed through the main conveyance section 161 in a state in which the back surface is an image formation surface.

The sheet passing path switching section (illustration is omitted) is disposed on the downstream side of the fixing section 23 in the recording material conveyance direction. The sheet passing path switching section switches the sheet passing route according to whether a recording material, which has been fed out from the fixing section 23, is discharged as it is, is reversed and discharged, or is conveyed to the back surface printing conveyance section 163. Specifically, the control section 30 controls the operation of the sheet passing path switching section (illustration is omitted) based on the processing content (single-sided/double-sided printing, face-up/face-down sheet discharge, or the like) of the image formation processing.

A recording material that has been fed from the sheet feed section 14 is conveyed to the image forming section 20 by the main conveyance section 161. Then, when the recording material passes through a secondary transfer section, toner images on the intermediate transfer belt 221 are collectively transferred onto a first surface (front surface) of the recording material, and fixing processing is performed at the fixing section 23. The recording material on which an image has been formed is discharged to the outside of the apparatus (for example, a sheet discharge unit (illustration is omitted)) by the sheet discharge section 15. In a case where images are formed on both sides of a recording material, the recording material on which an image has been formed on the first side is fed out to the switchback conveyance section 162. Then, the recording material is reversed by returning to the main conveyance section 161 by passing through the back surface printing conveyance section 163, and an image is formed on a second surface (back surface).

In the present embodiment, by appropriately setting a fog margin, toner fog on a recording material is suppressed. In addition, an appropriate amount of transfer residual fog toner is supplied to the drum cleaning apparatus 215 to suppress deterioration of the photoreceptor drum 213 and the drum cleaning blade 215a (cleaning member). Fog margin is indicated by the potential difference between a charging bias applied to a discharge electrode 214a of the charging apparatus 214 and a developing bias applied to the developer carrier 212a. A method of setting a fog margin will be described below.

Part of developing fog toner adhering to the photoreceptor drum 213 is transferred as transfer fog toner onto the intermediate transfer belt 221 and causes toner fog. The remainder of the developing fog toner is not transferred onto the intermediate transfer belt 221, but remains as transfer residual fog toner on the photoreceptor drum 213, and is removed by the drum cleaning blade 215a.

The fog margin is set such that a toner amount A1 of transfer fog toner (hereinafter referred to as the “transfer fog toner amount A1”) is equal to or less than a reference value and a toner amount A2 of the transfer residual fog toner (hereinafter referred to as the “transfer residual fog toner amount A2”) is equal to or greater than a first target value.

The reference value for the transfer fog toner amount A1 is, for example, a toner amount that satisfies a fog rank specified by a user. The fog margin when the transfer fog toner amount A1 becomes the reference value will be referred to as the “fog margin reference point”. In addition, the mode for setting the fog margin reference point will be referred to as the “fog detection mode”. A method of setting the fog margin reference point is disclosed in detail in PTL 2 and will be therefore briefly described here.

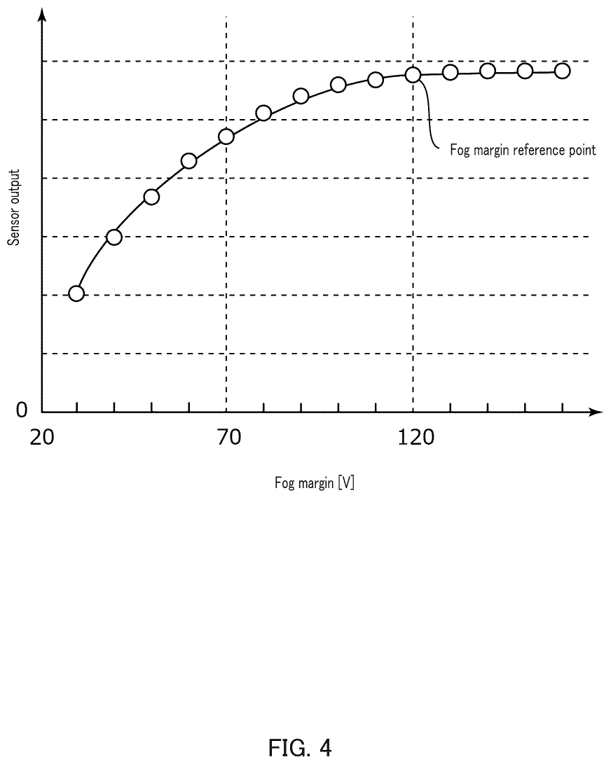

That is, the fog margin reference point is set based on a fog transfer characteristic. The fog transfer characteristic indicates the sensor output of the optical sensor 227 when the fog margin is changed in a stepwise manner in the fog detection mode (see FIG. 4). For example, in the fog transfer characteristic illustrated in FIG. 4, the fog margin when the sensor output is saturated and becomes constant can be set as the fog margin reference point. According to the fog transfer characteristic illustrated in FIG. 4, the fog margin reference point is 120 V.

The first target value for the transfer residual fog toner amount A2 is a toner amount necessary for suppressing deterioration of the photoreceptor drum 213 and the drum cleaning blade 215a.

When the toner amount of the developing fog toner is defined as a developing fog toner amount A0, the transfer residual fog toner amount A2 is expressed by the following equation 1.

$$A 2 = A 0 - A 1 \qquad ( Equation 1 )$$

In addition, when the transfer efficiency of the developing fog toner to the intermediate transfer belt 221 is TE1, the primary transfer efficiency TE1 is expressed by the following equation 2.

$$TE 1 = A 1 / A 0 \qquad ( Equation 2 )$$

The following equation 3 is derived from the equations 1 and 2. That is, the transfer residual fog toner amount A2 can be calculated using the transfer fog toner amount A1 and the primary transfer efficiency TE1. Note that, the transfer residual fog toner amount A2 can also be calculated using the developing fog toner amount A0 and the primary transfer efficiency TE1.

$$A 2 = A 1 ( 1 / TE 1 - 1 ) \qquad ( Equation 3 )$$

In the equation 3, the transfer fog toner amount A1 is directly detected based on the sensor output of the optical sensor 227. The transfer fog toner amount A1 varies depending on the fog margin to be set. Specifically, as the fog margin increases, the transfer fog toner amount A1 decreases.

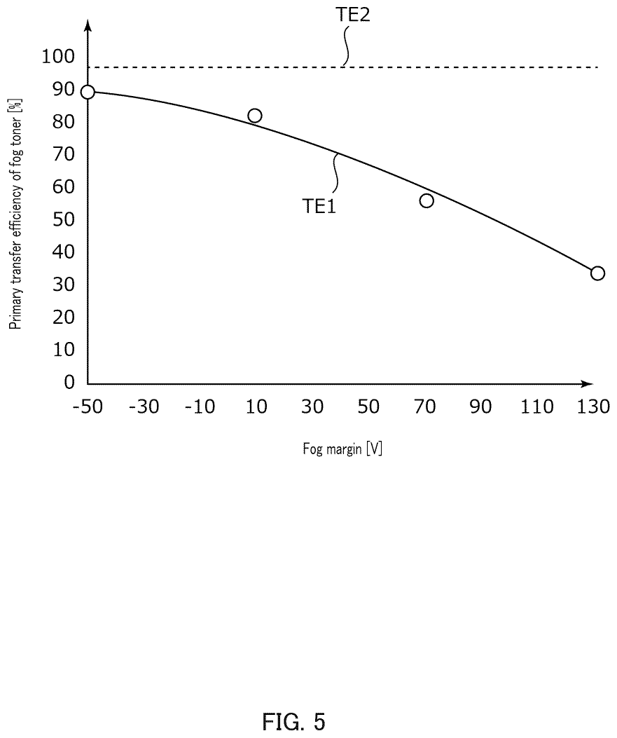

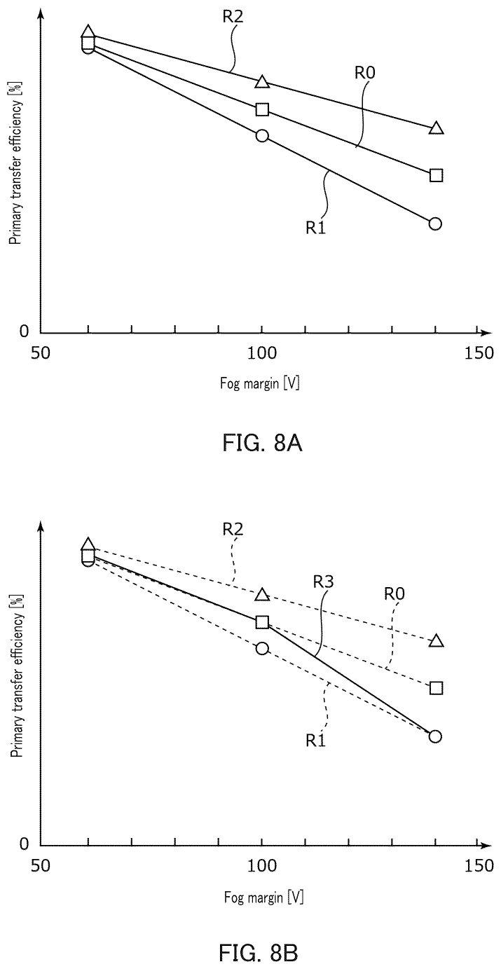

In addition, in the equation 3, the primary transfer efficiency TE1 with respect to the fog margin to be set is experimentally obtained in advance and is stored in, for example, the ROM 32 or the auxiliary storage section 34 (see FIGS. 5, 8A, and 8B).

FIG. 5 is a diagram illustrating the experimentally obtained primary transfer efficiency TE1 of developing fog toner. In FIG. 5, for comparison, a primary transfer efficiency TE2 of normal toner that has adhered to an image portion of the photoreceptor drum 213 is indicated by a broken line.

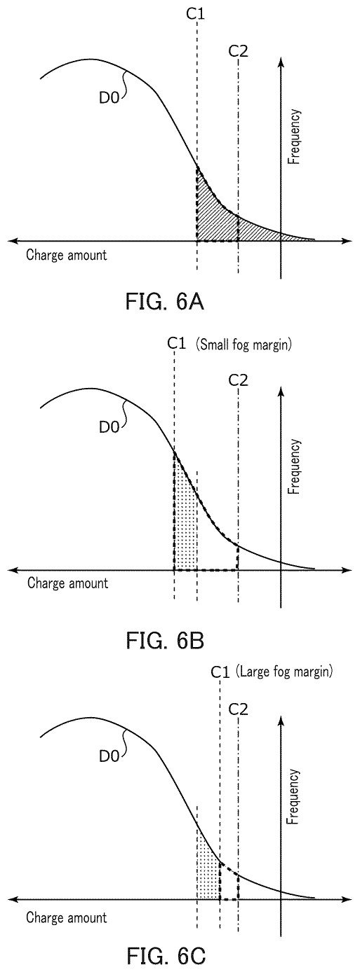

As illustrated in FIG. 5, the primary transfer efficiency TE2 of the normal toner is constant at about 95% regardless of the fog margin. On the other hand, the primary transfer efficiency TE1 of the developing fog toner tends to decrease as the fog margin increases. The primary transfer efficiency TE1 of the developing fog toner will be described in detail with reference to FIGS. 6A to 6C.

FIGS. 6A to 6C are model diagrams illustrating examples of a charge distribution of toner in the developing apparatus 212. The set fog margin is different among FIGS. 6A to 6C. As illustrated in FIGS. 6A to 6C, the charge distribution of toner may be considered to be substantially a normal distribution. In a charge distribution D0 illustrated in FIGS. 6A to 6C, an upper limit charge amount C1 is the maximum value of the charge amount of the toner that may become fog toner and is determined according to the fog margin. A lower limit charge amount C2 is the minimum value (transfer limit value) of the charge amount of the toner that may be primary-transferred, and is determined according to the primary transfer bias.

In FIG. 6A, in a case where the charge amount of the toner is smaller than the upper limit charge amount C1, the toner may adhere as developing fog toner to the photoreceptor drum 213. That is, the developing fog toner amount A0 is correlated with the area of the hatched portion in FIG. 6A. In addition, of the developing fog toner, toner having a charge amount larger than the lower limit charge amount C2 may be transferred onto the intermediate transfer belt 221. That is, the transfer toner amount A1 is correlated with the area of the portion surrounded by the broken lines in FIG. 6A.

As illustrated in FIG. 6B, as the fog margin decreases, the upper limit charge amount C1 shifts to the left and increases. Each of the developing fog toner amount A0 and the transfer fog toner amount A1 increases by the toner amount corresponding to the area of the shaded portion in FIG. 6B as compared with the case of FIG. 6A. That is, when the fog margin decreases, both the numerator and the denominator of the right side of the equation 2 indicating the primary transfer efficiency TE1 increase by the same amount, and thus, the primary transfer efficiency TE1 increases. It is considered that the ratio of the normally charged toner in the developing fog toner increases and the transfer efficiency of the developing fog toner as a whole is increased, and thus, the primary transfer efficiency TE1 increases.

On the other hand, as illustrated in FIG. 6C, as the fog margin increases, the upper limit charge amount C1 shifts to the right and decreases. Each of the fog toner amount A0 and the transfer fog toner amount A1 decreases by the toner amount corresponding to the area of the shaded portion in FIG. 6C as compared with the case of FIG. 6A. That is, when the fog margin increases, both the numerator and the denominator of the right side of the equation 2 indicating the primary transfer efficiency TE1 decrease by the same amount, and thus, the primary transfer efficiency TE1 decreases. It is considered that the ratio of the abnormally charged toner in the developing fog toner increases and the toner is less likely to be primary-transferred, and thus, the primary transfer efficiency TE1 decreases.

Accordingly, as illustrated in FIG. 5, the primary transfer efficiency TE1 of the developing fog toner decreases as the fog margin increases. When the primary transfer efficiency TE1 of developing fog toner is constant, an appropriate amount of transfer residual fog toner can be supplied to the drum cleaning blade 215a by controlling the developing fog toner amount A0 by the fog margin. However, as described above, the primary transfer efficiency TE1 of developing fog toner varies depending on the fog margin to be set. For this reason, in order to supply an appropriate amount of transfer residual fog toner to the drum cleaning blade 215a, it is necessary to set the fog margin in consideration of the primary transfer efficiency TE1.

As illustrated in FIG. 5, the primary transfer efficiency TE1 of the developing fog toner varies depending on the fog margin, but also varies depending on the charged state of the toner. The charge state of toner is typically a charge distribution of toner, and includes a distribution shape and an average charge amount.

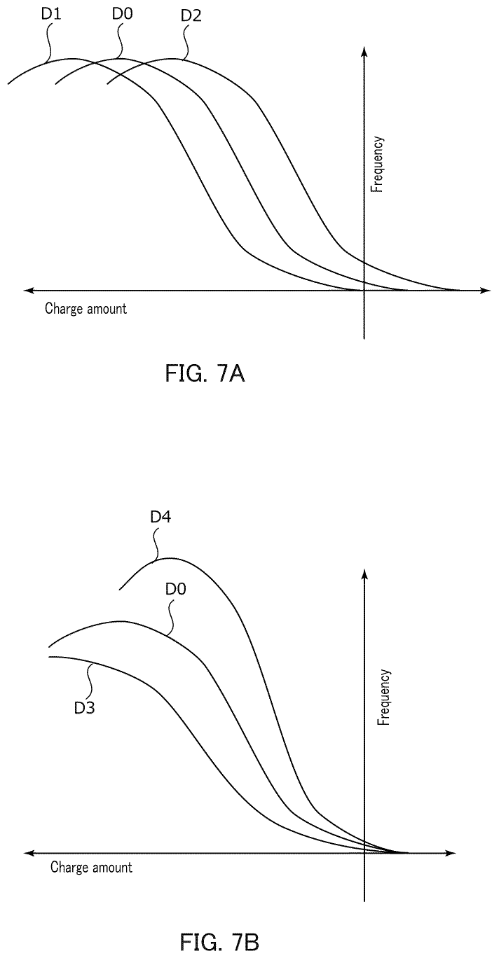

FIGS. 7A and 7B are model diagrams illustrating other examples of charge distributions of the toner in the developing apparatus 212. FIG. 7A illustrates charge distributions D0, D1, and D2 having the same distribution shape and different average charge amounts. FIG. 7B illustrates charge distributions D0, D3, and D4 having different average charge amounts and distribution shapes.

As illustrated in FIG. 7A, the charge distribution D1 is shifted to the left side with respect to the charge distribution D0 (see FIG. 6A and the like) and has a large average charge amount. In this case, compared with the charge distribution D0, the amount of abnormally charged toner having a small charge amount is small and developing fog is less likely to occur, and thus, the fog margin for achieving the target fog rank may be small.

On the other hand, the charge distribution D2 is shifted to the right side with respect to the charge distribution D0 and has a small average charge amount. In this case, compared with the charge distribution D0, the amount of abnormally charged toner is large and developing fog is likely to occur, and thus, it is necessary to increase the fog margin for achieving the target fog rank.

As illustrated in FIG. 7B, the charge distribution D3 is shifted to the left side with respect to the charge distribution D0 (refer to the 6A in the standard) and has a large average charge amount. In addition, the charge distribution D3 has a laterally wide, flat, and broad shape with respect to the charge distribution D0, and has a large standard deviation σ. In this case, compared with the charge distribution D0, the amount of abnormally charged toner is small and developing fog is less likely to occur, and thus, the fog margin for achieving the target fog rank may be small.

On the other hand, the charge distribution D4 is shifted to the right side with respect to the charge distribution D0 and has a small average charge amount. In addition, the charge distribution D4 has a laterally narrow, pointed, and sharp shape with respect to the charge distribution D0, and has a small standard deviation σ. In this case, compared with the charge distribution D0, the amount of abnormally charged toner is large and developing fog is likely to occur, and thus, it is necessary to increase the fog margin for achieving the target fog rank.

In FIGS. 7A and 7B, the average charge amount (the center value of the normal distribution) of each of the charge distributions D0 to D4 is correlated with the fog margin reference point acquired in the fog detection mode. By associating the fog margin reference point with the average charge amount, it is possible to predict the average charge amount of the current toner charge distribution by using the fog margin reference point as input information.

In addition, in FIGS. 7A and 7B, the distribution shape of each of the charge distributions D0 to D4 is correlated with the inclination of the amount of change in the sensor output acquired in the fog detection mode. Thus, it is possible to predict the distribution shape of the current toner charge distribution by using the inclination of the amount of change in the sensor output acquired in the fog detection mode as input information.

Further, by experimentally obtaining the relationship between the fog margin and the primary transfer efficiency TE1 in association with a plurality of representative charge distributions (average charge amounts and distribution shapes), it is possible to calculate the primary transfer efficiency TE1 with respect to the set value of the fog margin and further the transfer residual fog toner amount A2 accurately. Note that, the relationship between the fog margin and the primary transfer efficiency TE1 may be set for each of the imaging sections 21Y, 21M, 21C, and 21K.

FIGS. 8A and 8B illustrate relationships between the fog margin set in association with the charge distribution and the primary transfer efficiency TE1. In FIG. 8A, the relationship between the fog margin in association with the distribution shape of the charge distribution (R0: default, R1: broad, R2: sharp) and the primary transfer efficiency TE1 is set. In FIG. 8A, the average charge amounts of the charge distributions are the same.

Note that, usually, the distribution shape of the charge distribution of toner tends to be broader for higher charging and sharper for lower charging. Thus, the relationship between the fog margin and the primary transfer efficiency TE1 may be uniquely set as indicated by a solid line R3 in FIG. 8B. In this case, the primary transfer efficiency TE1 can be determined by predicting the charge distribution of toner by using only the fog margin reference point as input information.

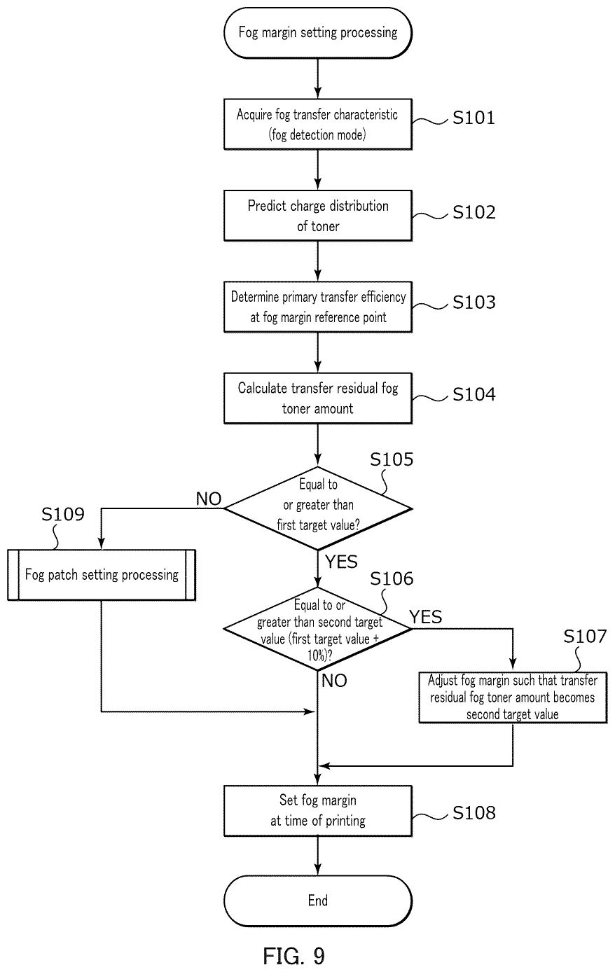

FIG. 9 is a flowchart illustrating an example of fog margin setting processing that is executed by the control section 30. This processing is implemented, for example, by the CPU 31 executing a fog margin setting program accommodated in the ROM 32 in response to turning on the power supply of the image forming apparatus 1.

In step S101 of FIG. 9, the control section 30 acquires a fog transfer characteristic in the fog detection mode. The fog margin reference point and the inclination of the amount of change in the sensor output can be obtained from the fog transfer characteristic illustrated in FIG. 4.

In step S102, the control section 30 predicts the charge distribution of toner. Specifically, it is possible to predict the average charge amount and the distribution shape of the current toner charge distribution by using, as input information, the fog margin reference point and the inclination of the amount of change in the sensor output acquired in step S101. Of the relationships between the fog margin and the primary transfer efficiency TE1 that have been experimentally acquired in advance (see FIGS. 8A and 8B), the relationship to be used in calculating the primary transfer efficiency TE1 is identified.

In step S103, control section 30 determines the primary transfer efficiency TE1 at the fog margin reference point. Specifically, the primary transfer efficiency TE1 corresponding to the fog margin reference point can be obtained from the relationship between the fog margin and the primary transfer efficiency identified in step S102 (see FIGS. 8A and 8B).

In step S104, the control section 30 calculates the transfer residual fog toner amount A2. Specifically, in the equation 3, the transfer residual fog toner amount A2 can be calculated using the sensor output (the transfer fog toner amount A1) corresponding to the fog margin reference point and the primary transfer efficiency TE1 determined in step S103.

In step S105, the control section 30 judges whether the transfer residual fog toner amount A2 calculated in step S104 is equal to or greater than the first target value. In a case where the transfer residual fog toner amount A2 is equal to or greater than the first target value (“YES” in step S105), the control section 30 proceeds to the processing in step S106. In a case where the transfer residual fog toner amount A2 is not equal to or greater than the first target value (“NO” in step S105), the control section 30 proceeds to the processing in step S109.

In step S106, the control section 30 judges whether the transfer residual fog toner amount A2 is equal to or greater than a second target value. The second target value is a target value obtained by adding a margin to the first target value, and is set to, for example, the first target value+10%. In a case where the transfer residual fog toner amount A2 is equal to or greater than the second target value (“YES” in step S106), the control section 30 proceeds to the processing in step S107. In a case where the transfer residual fog toner amount A2 is not equal to or greater than the second target value (“NO” in step S106), the control section 30 proceeds to the processing in step S108.

In step S107, the control section 30 adjusts the fog margin such that the transfer residual fog toner amount A2 becomes the second target value. Specifically, the control section 30 sets that the fog margin is larger than the fog margin reference point in a range in which the transfer residual fog toner amount A2 does not fall below the second target value. In a case where the transfer residual fog toner amount A2 is larger than the second target value, a sufficient transfer residual fog toner amount A2 can be ensured even when the fog margin is made larger than the fog margin reference point.

In step S108, the control section 30 sets the fog margin at the time of printing. In a case where it has been judged in step S106 that the transfer residual fog toner amount A2 is equal to or greater than the second target value, the fog margin is set to a value larger than the fog margin reference point. In a case where it has been judged in step S106 that the transfer residual fog toner amount A2 is less than the second target value, the fog margin is set to the fog margin reference point.

Since the fog margin is set to be equal to or greater than the fog toner reference point obtained from the fog transfer characteristic, toner fog is suppressed, and the fog rank specified by the user can be satisfied. In addition, the fog margin is set such that the transfer residual fog toner amount A2 is equal to or greater than the first target value, preferably equal to or greater than the second target value, and thus, an appropriate amount of transfer residual fog toner can be supplied to the drum cleaning apparatus 215, and deterioration of the photoreceptor drum 213 and the drum cleaning blade 215a can be suppressed.

In step S105, in a case where it has been judged that the transfer residual fog toner amount A2 is less than the first target value, an appropriate amount of transfer residual fog toner cannot be supplied to the drum cleaning apparatus 215 while suppressing toner fog. In this case, in step S108, the fog margin reference point is set as the fog margin at the time of printing, and toner fog is suppressed.

On the other hand, in order to secure an appropriate amount of the transfer residual fog toner amount A2, fog patch setting processing is performed in step S109. In the fog patch setting processing, a fog patch is formed in a non-image portion of the photoreceptor drum 213 with a toner amount capable of replenishing an insufficient transfer residual fog toner amount A2, and the transfer residual fog toner amount A2 is forcibly increased without being transferred onto the intermediate transfer belt 221. The printing of the fog patch may be performed, for example, in a blank portion between images (so-called inter-image portion) in a case where a plurality of images is continuously formed, or may be performed when the image forming apparatus 1 is activated and/or stopped.

In addition, when the fog patch is printed, a reverse bias may be applied in a primary transfer section so that the transfer rate to the intermediate transfer belt 221 is 0% and the fog patch is all supplied to the drum cleaning apparatus 215.

As described above, the image forming apparatus 1 according to the embodiment includes the following features solely or in combination as appropriate.

That is, the image forming apparatus 1 includes: the photoreceptor drum 213, the developer carrier 212a that supplies toner to the photoreceptor drum 213; the drum cleaning blade 215a (cleaning member) that removes transfer residual toner remaining on the photoreceptor drum 213 after transfer to the intermediate transfer belt 221 (transfer body); the optical sensor 227 that detects the toner amount of fog toner; and the control section 30 that sets a fog margin. The control section 30 predicts a charge distribution of toner in the developing apparatus 212 based on the fog transfer characteristic (see FIG. 4) indicating the sensor output of the optical sensor 227 when the fog margin is changed in a stepwise manner, calculates the transfer residual fog toner amount A2 by using the sensor output (the transfer fog toner amount A1) corresponding to the set fog margin and transfer efficiency (see FIGS. 8A and 8B) set in association with the charge distribution, and sets the fog margin such that the transfer residual fog toner amount A2 is equal to or greater than the first target value set in advance.

According to the image forming apparatus 1, it is possible to set an appropriate fog margin in consideration of the fog margin to be set and variations in transfer efficiency due to the charge distribution of the toner in the developing apparatus 212. Accordingly, toner fog can be suppressed, and deterioration of the photoreceptor drum 213 and the drum cleaning blade 215a can be suppressed by supplying an appropriate amount of transfer residual toner fog. As a result, it is possible to suppress stain and streak of the photoreceptor drum 213 caused by poor cleaning performance, and it is possible to improve the quality of images formed by the image forming apparatus 1.

Specifically, in the image forming apparatus 1, the control section 30 determines, based on the fog transfer characteristic, a fog margin reference point at which the transfer fog toner amount A1 is equal to or less than a reference value, and predicts the average charge amount of the charge distribution by using the fog margin reference point as input information. Thus, an appropriate fog margin can be set in consideration of variations in transfer efficiency due to the average charge amount of the toner.

Further, in the image forming apparatus 1, the control section 30 predicts the distribution shape of the charge distribution by using, as input information, the inclination of the amount of change in the sensor output in the fog transfer characteristic in addition to the fog margin reference point. Thus, the fog margin can be set in consideration of not only the average charge amount of the toner but also variations in the transfer efficiency due to the distribution shape, and a more appropriate fog margin can be set.

In the image forming apparatus 1, the control section 30 calculates the transfer residual fog toner amount A2 by using the sensor output corresponding to the fog margin reference point and the transfer efficiency set in association with the charge distribution. The transfer residual fog toner amount A2 is calculated using the data acquired in the fog detection mode, and the fog margin is adjusted by using the calculated transfer residual fog toner amount A2, and thus, it is possible to easily set an appropriate fog margin.

In the image forming apparatus 1, the control section 30 sets the fog margin to be larger than the fog margin reference point in a case where the transfer residual fog toner amount A2 corresponding to the fog margin reference point is equal to or greater than the second target value (for example, the first target value+10%) larger than the first target value (step S106 to S108 in FIG. 9). Thus, the developing fog toner amount A0 can be reduced, and the effect of suppressing toner fog is enhanced. In addition, it is possible to reduce the toner consumption amount for suppressing the wear of the photoreceptor drum 213 and the drum cleaning blade 215a.

In the image forming apparatus 1, the control section 30 sets the fog margin to the fog margin reference point in a case where the transfer residual fog toner amount A2 corresponding to the fog margin reference point is larger than the first target value and smaller than the second target value (the first target value+10%) (steps S106 and S107 in FIG. 9). Thus, an appropriate fog margin can be easily set.

In the image forming apparatus 1, the control section 30 replenishes the transfer residual fog toner amount with a fog patch in a case where the transfer residual fog toner amount A2 corresponding to the fog margin reference point is smaller than the first target value. Thus, even in a case where the transfer residual fog toner amount A2 is insufficient, deterioration of the photoreceptor drum 213 and the drum cleaning blade 215a can be surely suppressed.

Although the disclosure made by the present inventor has been specifically described above based on an embodiment, the present disclosure is not limited to the above-described embodiment and can be modified without departing from the spirit thereof.

For example, instead of the transfer fog toner amount A1 detected by the optical sensor 227, the developing fog toner amount A0 on the photoreceptor drum 213 may be detected by the optical sensor, and the transfer residual fog toner amount A2 may be calculated using the developing fog toner amount A0.

The present disclosure is also applicable to a monochrome image forming apparatus.

Although embodiments of the present invention have been described and illustrated in detail, the disclosed embodiments are made for purpose of illustration and example only and not limitation. The scope of the present invention should be interpreted by terms of the appended claims.

What is claimed is:

1. An image forming apparatus, comprising:
a photoreceptor drum;
a developer carrier that supplies toner to the photoreceptor drum;
a cleaning member that removes transfer residual toner remaining on the photoreceptor drum after transfer to a transfer body;
an optical sensor that detects a toner amount of fog toner; and
a hardware processor that sets a fog margin, wherein
the hardware processor
predicts a charge distribution of toner in a developing apparatus based on a fog transfer characteristic indicating a sensor output of the optical sensor when the fog margin is changed in a stepwise manner,
calculates a transfer residual fog toner amount by using the sensor output corresponding to the set fog margin and transfer efficiency set in association with the charge distribution, and
sets the fog margin such that the transfer residual fog toner amount is equal to or greater than a first target value set in advance.

2. The image forming apparatus according to claim 1, wherein
the hardware processor determines, based on the fog transfer characteristic, a fog margin reference point at which a transfer fog toner amount is equal to or less than a reference value, and predicts an average charge amount of the charge distribution by using the fog margin reference point as input information.

3. The image forming apparatus according to claim 2, wherein
the hardware processor predicts a distribution shape of the charge distribution by using, as the input information, an inclination of an amount of change in the sensor output in the fog transfer characteristic in addition to the fog margin reference point.

4. The image forming apparatus according to claim 2, wherein
the hardware processor calculates the transfer residual fog toner amount by using the sensor output corresponding to the fog margin reference point and the transfer efficiency set in association with the charge distribution.

5. The image forming apparatus according to claim 2, wherein
the hardware processor sets the fog margin to be larger than the fog margin reference point in a case where the transfer residual fog toner amount corresponding to the fog margin reference point is equal to or greater than a second target value larger than the first target value.

6. The image forming apparatus according to claim 5, wherein
the hardware processor sets the fog margin to the fog margin reference point in a case where the transfer residual fog toner amount corresponding to the fog margin reference point is larger than the first target value and smaller than the second target value.

7. The image forming apparatus according to claim 6, wherein
the hardware processor replenishes the transfer residual fog toner amount with a fog patch in a case where the transfer residual fog toner amount corresponding to the fog margin reference point is smaller than the first target value.
